(19) United States
(12) Patent Application Publication
(10) Pub. No.: US 2018/0270908 A1
(43) Pub. Date: Sep. 20, 2018

(54) Voltage-Leveled Heating Cable with Adjustable Power Output

(71) Applicant: Pentair Flow Services AG, Schaffhausen (CH)

(72) Inventors: Mohammad Kazemi, San Jose, CA (US); Linda D.B. Kiss, San Mateo, CA (US); Edward H. Park, Santa Clara, CA (US)

(21) Appl. No.: 15/921,571

(22) Filed: Mar. 14, 2018

Related U.S. Application Data
(60) Provisional application No. 62/471,202, filed on Mar. 14, 2017.

(51) Int. Cl. H05B 3/56; H05B 1/02

(52) U.S. Cl. CPC H05B 3/56; H05B 2203/02; H05B 2203/007; H05B 1/0291

(57) ABSTRACT

Voltage-leveled self-regulating heater cables with one or more cores are disclosed, each core having a positive temperature coefficient (PTC) material encapsulating a conductor. A conductive foil/wire and/or conductive ink portions cover a fraction of the cores. The conductive foil/wire may be formed about the cores circumferentially, and the conductive ink portions may be formed over the cores lengthwise. In embodiments with two or more separated conductive ink portions, the conductive foil/wire may be formed to electrically connect the conductive ink portions. A desired power output may be achievable by adjusting the fraction of the cores covered by conductive material.

### CROSS REFERENCE TO RELATED APPLICATIONS

This application claims priority from U.S. Provisional Application No. 62/471,202 filed Mar. 14, 2017, which is hereby incorporated by reference as if fully set forth herein.

### BACKGROUND

Heater cables, such as self-regulating heater cables, can provide heat in a great variety of applications. Such cables can be used, for example, to protect against freezing, to maintain viscosity of a fluid in a pipe, or to otherwise help regulate the temperature of conduits and materials. Heater cables offer the benefit of being field-configurable. For example, heater cables may be applied or installed as needed without the requirement that application-specific heating assemblies be custom-designed and manufactured, though heater cables may be designed for application-specific uses in some instances.

In some approaches, a heater cable operates by use of two or more bus wires having a high conductance coefficient (i.e., low resistance). To power a heater cable that uses bus wires, the bus wires are typically connected at one end of the cable to a power supply, with the bus wires terminating at the other end of the cable. The bus wires are coupled to differing voltage supply levels to create a voltage potential between the bus wires. A self-regulating heater cable employs a positive temperature coefficient (PTC) material situated between the bus wires; current is allowed to flow through the PTC material, thereby generating heat by resistive conversion of electrical energy into thermal energy. As the temperature of the PTC material increases, so does its resistance, thereby reducing the current through the PTC material and, consequently, the heat generated via resistive heating. The heater cable is thus self-regulating in that, as temperatures rise, less heat tends to be generated.

Heater cables can exhibit high temperature variations throughout the cable, both lengthwise along the length of the cable and across a cross-section of the cable. These high temperature variations may be caused by small high-active heating volumes within the heater cable that can create localized heating, as opposed to heat spread over a larger surface area or volume. There are two major designs for conventional self-regulating heater cables: monolithic and fiber-wrapped design. In both, there is a small portion of the core/fiber that is active and generates most of the power, resulting in a significant hot spot in that region. Additionally, the power output of conventional cables is normally determined by its core composition, and consequently, once a window of core composition is selected for a heater cable, its power output is not readily adjustable. What is needed is a solution that addresses these and other shortcomings of conventional self-regulating heater cables.

### SUMMARY

Embodiments of the invention described herein provide for exemplary voltage-leveled self-regulating heater cables comprising one or more cores, each core having a positive temperature coefficient (PTC) material encapsulating a conductor. Electrically conductive material such as conductive foil, conductive wire and/or conductive ink may be applied to cover a portion of the cores. The conductive material may be formed about the cores circumferentially, and the conductive ink portions may be formed over the cores lengthwise. In embodiments with two (or more) separate conductive ink portions and a conductive foil in electrical contact with the cores, the conductive foil may be formed to electrically connect the conductive ink portions.

Such heater cable configurations allow a desired power output to be achieved by adjusting the fraction of the cores covered by conductive material, which may be defined by a wrapping density of the conductive material. In some embodiments, substantially full coverage could provide maximal power output, while zero or near-zero coverage could provide a zero or a small power output. Heater cables having different power outputs can be manufactured from the same extruded cores by varying the wrapping density (“coverage percentile”) conductive materials applied to the surfaces of the cores of each heater cable. In addition to adjustability in heater cable power output by selection of wrapping density, lower core temperature, lower sheath temperature, longer lifetime, reduced core material usage, and less manufacturing waste (resulting from larger manufacturing target windows), can be achieved.

In an embodiment of the present invention, a voltage-leveled self-regulating heater cable may include a conductor, a core that encapsulates the conductor, and a conductive material in contact with only a portion of an outer surface of the core. The core may include positive temperature coefficient material.

In some embodiments, the voltage-leveled self-regulating heater cable may include conductive ink in contact with the outer surface of the core and in contact with at least a portion of the conductive material.

In some embodiments, the voltage-leveled self-regulating heater cable may include an additional conductor and an additional core that encapsulates the additional conductor. The additional core may include positive temperature coefficient material.

In some embodiments, the voltage-leveled self-regulating heater cable may include a first conductive ink portion extending lengthwise along the core and a second conductive ink portion extending lengthwise along the additional core.

In some embodiments, the voltage-leveled self-regulating heater cable may include a web extending between the core and the additional core. The web may be electrically active or electrically inactive.

In some embodiments, the core may physically contact the additional core.

In some embodiments, the conductive material may include an electrically conductive wire that is wrapped around a portion of the core.

In an embodiment of the present invention, a voltage-leveled self-regulating heater cable may include a first conductor, a first core that encapsulates the first conductor, a second conductor, a second core that encapsulates the second conductor, and conductive material in contact with outer surfaces of the first core and the second core. The first core may include positive temperature coefficient material. The second core may include positive temperature coefficient material. The conductive material may electrically couple the first core to the second core. The conductive material may be metal or conductive ink.

In some embodiments, the voltage-leveled self-regulating heater cable may include first conductive ink printed on a first portion of the first core and second conductive ink printed on a second portion of the second core. The conductive material may be in physical contact with the first conductive ink and the second conductive ink.

In some embodiments, the conductive material may include electrically conductive metal foil that encircles the first and second cores.

In some embodiments, the voltage-leveled self-regulating heater cable may include a web interposed between the first core and the second core. The web may connect the first core to the second core. The web may be electrically active or electrically inactive.

In an embodiment of the present invention, a method of manufacturing voltage-leveled self-regulating heater cables may include applying conductive material to a first pair of extruded cores at a first wrapping density with manufacturing equipment to produce a first voltage-leveled self-regulating heater cable. The first pair of extruded cores may include positive temperature coefficient material. The first pair of extruded cores may each encapsulate a respective conductor. A coverage percentile of the applied conductive material may be less than 100 percent.

In some embodiments, the method may further include automatically determining, with a resistivity measurement device, a resistivity of the first pair of extruded cores, and determining, with a processor of a computer system, the first wrapping density based on at least the determined resistivity of the first pair of extruded cores.

In some embodiments, the first wrapping density may be selected based on a predefined power output for the first voltage-leveled self-regulating heater cable.

In some embodiments, the method may include automatically determining, with a resistivity measurement device of the manufacturing equipment, a first resistivity of the first pair of extruded cores, determining, based on the first resistivity, that the conductive material applied to the first pair of extruded cores at the first wrapping density produces the first voltage-leveled self-regulating heater cable with the predefined power output, automatically determining, with the resistivity measurement device, a second resistivity of a second pair of extruded cores comprising the positive temperature coefficient material encapsulating a third conductor and a fourth conductor, the second resistivity being different from the first resistivity, determining, based on the second resistivity, that the conductive material applied to the second pair of extruded cores at a second wrapping density produces a second voltage-leveled self-regulating heater cable with the predefined power output, and applying, with the resistivity measurement device to the second pair of extruded cores, the conductive material at the second wrapping density to produce the second voltage-leveled self-regulating heater cable.

In some embodiments, applying the conductive material to the extruded cores may include wrapping electrically conductive wire around the first pair of extruded cores at the first wrapping density.

The foregoing and other advantages of the disclosed apparatuses and methods will appear from the following description. In the description, reference is made to the accompanying drawings which form a part hereof, and in which there is shown by way of illustration exemplary embodiments of the invention. Such embodiments do not necessarily represent the full scope of the contemplated apparatuses and methods, however, and reference is made therefore to the claims in subsequent applications claiming priority to this application for interpreting the scope of the invention.

### BRIEF DESCRIPTION OF DRAWINGS

FIG. 1A is a perspective view of an illustrative heater cable with conductive material situated about a pair of cores connected by a web in accordance with an embodiment of the invention.

FIG. 1B is an end view of the exemplary cable of FIG. 1A, encased in polymer jackets in accordance with an embodiment of the invention.

FIG. 1C is a perspective view of the exemplary cable of FIG. 1B in accordance with an embodiment of the invention.

FIG. 2 is a perspective view of an illustrative heater cable with a conductive ink situated along a length of a pair of cores connected by a web and with conductive material situated about the pair of cores in accordance with an embodiment of the invention.

FIG. 3 is an end view of an illustrative heater cable with conductive material situated about a pair of cores that are in direct contact without an intervening web in accordance with an embodiment of the invention.

FIG. 4 is a perspective view of the illustrative heater cable of FIGS. 1A-1C with jacket layers pulled back to reveal interior elements, and with a line A-A indicating the location relevant to the cross-sectional views of FIGS. 5A-6B in accordance with an embodiment of the invention.

FIG. 5A is a cross-sectional view of the illustrative heater cable of FIG. 4 along line A-A, showing a radial voltage gradient occurring in the area of the conductive material in the heater cable, the heater cable including an electrically active web, in accordance with an embodiment of the invention.

FIG. 5B is a cross-sectional view of the exemplary heater cable of FIG. 4 along line A-A, showing a temperature gradient occurring in the area of the conductive material in the heater cable, the heater cable including an electrically active web, in accordance with an embodiment of the invention.

FIG. 6A is a cross-sectional view of the illustrative heater cable of FIG. 4 along line A-A, showing a radial voltage gradient occurring in the area of the conductive material in the heater cable, the heater cable including an electrically inactive web, in accordance with an embodiment of the invention.

FIG. 6B is a cross-sectional view of the illustrative heater cable of FIG. 4 along line A-A, showing a temperature gradient occurring in the area of the conductive material in the heater cable, the heater cable including an electrically inactive web, in accordance with an embodiment of the invention.

FIG. 7A is a cross-sectional view of an illustrative heater cable with wires wrapped on cores, in accordance with an embodiment of the invention.

FIG. 7B is a top-down view of the illustrative heater cable of FIG. 7A showing wire wrapped around the cores, in accordance with an embodiment of the invention.

FIG. 8 is an illustrative process flow chart for a method of applying conductive material to one or more extruded cores with a wrapping density that is determined based on a measured resistivity of the one or more extruded cores, in accordance with an embodiment of the invention.

### DETAILED DESCRIPTION

Before the present invention is described in further detail, it is to be understood that the invention is not limited to the particular aspects described. It is also to be understood that the terminology used herein is for the purpose of describing particular aspects only, and is not intended to be limiting. The scope of the present invention will be limited only by the claims. As used herein, the singular forms “a”, “an”, and “the” include plural aspects unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising”, “including”, or “having” should be interpreted as referring to elements, components, or steps in a non-exclusive manner, so the referenced elements, components, or steps may be combined with other elements, components, or steps that are not expressly referenced. Aspects referenced as “comprising”, “including”, or “having” certain elements are also contemplated as “consisting essentially of” and “consisting of” those elements, unless the context clearly dictates otherwise. It should be appreciated that aspects of the disclosure that are described with respect to a system are applicable to the methods, and vice versa, unless the context explicitly dictates otherwise.

Numeric ranges disclosed herein are inclusive of their endpoints. For example, a numeric range of between 1 and 10 includes the values 1 and 10. When a series of numeric ranges are disclosed for a given value, the present disclosure expressly contemplates ranges including all combinations of the upper and lower bounds of those ranges. For example, a numeric range of between 1 and 10 or between 2 and 9 is intended to include the numeric ranges of between 1 and 9 and between 2 and 10.

As stated above, the power output of a conventional self-regulating (SR) heater cable is generally determined by the core composition of the heater cable, which is set during the fabrication of the core(s) and may be subject to unintentional variations as a result of manufacturing non-idealities. When the core composition properties (e.g., resistivity) of an extruded core fall outside of an acceptable window (e.g., defined in part by the desired power output of the heating cable(s) being manufactured using the extruded core(s)), the extruded core(s) would conventionally be scrapped, resulting in wasted time, energy, and materials.

In contrast, embodiments of the present invention allow for the power output of an SR heating cable to be selected during manufacturing of the SR heating cable by applying conductive material (e.g., electrically conductive material) to one or more surfaces of the core(s), the conductive material being applied with a selected (in some embodiments, automatically selected) wrapping density corresponding to a coverage percentile, subsequent to fabricating the core(s). This “coverage percentile,” as used herein, refers to a percentage of the outer surface of the core(s) that is covered by the conductive material. For example, the coverage percentile and corresponding wrapping density needed to be applied to the core(s) in order to meet a particular set of power output requirements may be determined automatically based on a measured resistivity of the core(s). A 100% coverage percentile may provide maximum cable power output, while a 0% coverage percentile may result in zero or only a small power output, depending on the configuration of the heater cable. In some embodiments, heater cables with different power outputs can be made from the same extruded core(s), and the desired power output of the heater cable can be achieved in a later process step by selecting the coverage percentile of the conductive material (e.g., foil, wire and/or conductive ink) over the core(s) of the heater cable. Some embodiments of the heater cables described herein may be next-generation, monolithic (solid core) SR heater cables, able to achieve thermal balancing (e.g., with no hot spots) as well as a desired power output that is set by selecting the coverage percentile of the conductive material over the core(s).

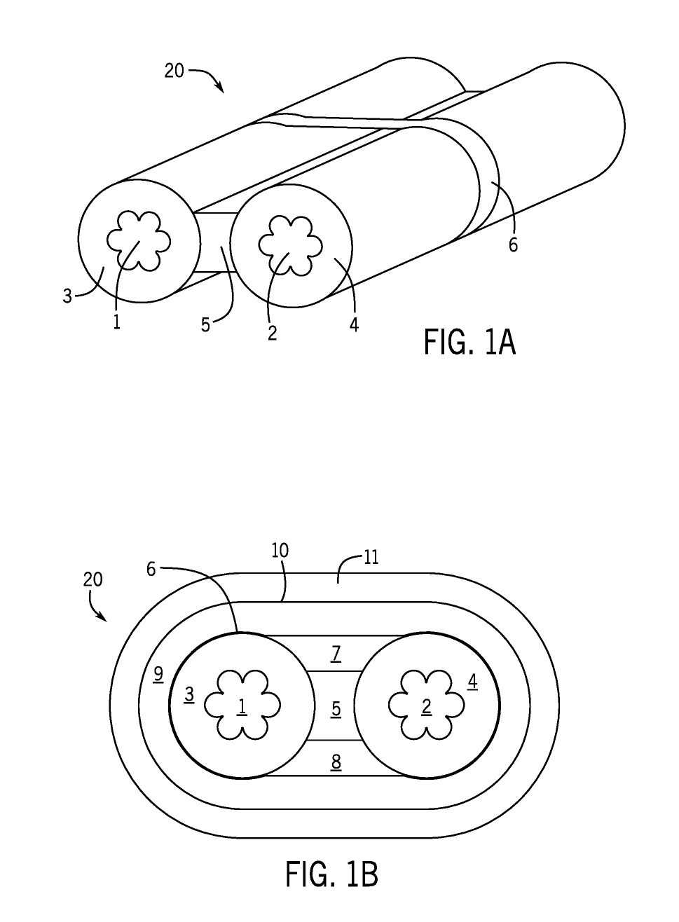

FIGS. 1A-1C show views of an illustrative SR heater cable 20 from various angles. As shown in FIG. 1A, one or more conductors may be encapsulated within cores 3 and 4, respectively. The cores 3 and 4 may be made from a positive temperature coefficient (PTC) conductive polymer material (e.g., crosslinked or crosslinkable polyethylene or fluoropolymer). An optional web 5 may be included in SR heater cable 20, disposed between and in physical contact with the cores 3 and 4. In some embodiments, web 5 may be an electrically conductive or insulating spacer instead of a web. The web 5, may be either electrically active or electrically inactive. It is noted that the degree to which the web 5 is electrically “active” or “inactive” is defined by how electrically conductive the web 5 is. For example, if the web 5 is made from a material that is moderately or highly electrically conductive, the web 5 may be considered electrically active. Alternatively, if the web 5 is made from a material that is highly electrically insulating, the web 5 may be considered electrically inactive. In some embodiments, the web 5, when electrically active, may include PTC material, which may be the same PTC material from which the cores 3 and 4 are formed. Alternatively, in some embodiments, the web 5, when electrically active, may include PTC material having higher conductivity than that of the cores 3 and 4 but lower conductivity than the conductive material 6 (described below).

A conductive material 6, which may have a high electrical conductivity (e.g., the electrical resistivity of the conductive material 6 may be below 500 ohm·cm) may be formed or applied to physically and electrically contact a portion of the outer surfaces of cores 3 and 4 in order to enhance voltage leveling on the cores 3 and 4. The conductive material 6 may, for example, be a conductive wire (e.g., copper wire, nickel coated copper wire, or any other applicable conductive wire), conductive foil (e.g., aluminum foil or any other applicable conductive, metal foil), or patterned conductive ink (e.g., which may be film-forming). For embodiments in which the conductive material 6 is patterned conductive ink, the conductive ink may be applied directly onto the cores 3 and 4 or, alternatively, may be applied onto an interior surface of a polymer jacket 9 situated around the cores 3 and 4. The width (i.e., longitudinal span along the cores 3 and 4) of the conductive material 6 per unit of heater cable length corresponds with the coverage percentile of the conductive material 6, and is positively correlated with a power output of the cable. The conductive material 6 may be configured, for example, as a thin band that is placed around the cores 3 and 4 with a desired pitch and may electrically couple the cores 3 and 4 together. The thin band may, for example, be round, flat, elliptical, tri-lobal, or any other applicable shape. Alternatively, the conductive material 6 may be a continuous strip that is wrapped about a desired length of the cores 3 and 4 with a desired wrapping density. The wrapping density of the conductive material 6, in combination with the width of the conductive material 6, may determine the coverage percentile that defines the percentage of the outer surfaces of the cores 3 and 4 that are covered by the conductive material 6.

As shown in FIGS. 1B and 1C, a ground layer 10, which could be, for example, a metallic foil wrap or an assembly of small strands of drain wires, may provide an earth ground for the SR heater cable 20. The ground layer 10 may also help transfer heat around the circumference of the SR heater cable 20. The ground layer 10 may be situated around a thin inner polymer jacket 9, which may provide dielectric separation between the cores 3 and 4 and the ground layer 10. Airgaps 7, 8 may separate the web/spacer 5 from the polymer jacket 9. The presence and the thickness of the airgaps 7, 8 depends largely on the thickness of web 5. An outer polymer jacket 11 may be situated about the ground layer 10 to provide environmental protection for the SR heater cable 20; the outer jacket 11 may include reinforcing fibers to enhance environment protection.

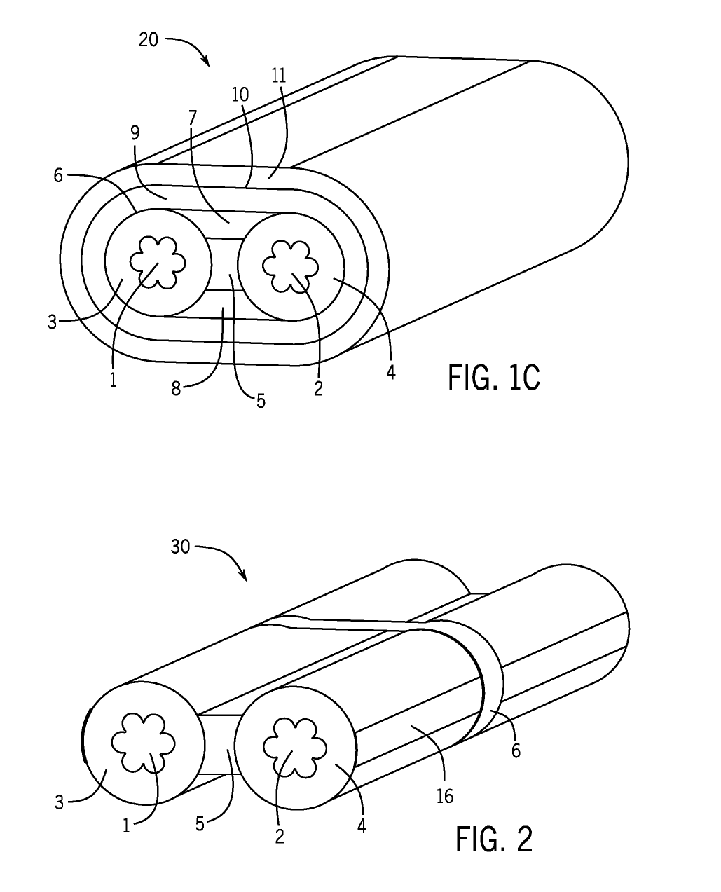

In alternative embodiments conductive ink may be applied to the core(s) a SR heater cable to enhance conductive contact with the surface of the core(s) of the heater cable. FIG. 2 shows an SR heater cable 30 that includes both conductive ink and conductive material in contact with cores of the SR heater cable 30. As shown, two thin conductive ink portions 16 (also with a high electrical conductivity—e.g., the electrical resistivity of the ink may be below 500 ohm·cm) circumferentially cover a portion of cores 3 and 4, and longitudinally extend continuously along the length of the cores 3 and 4 on opposite sides of the SR heater cable 30. The fraction of the circumference of the cores 3 and 4 covered by (e.g., in effective electrical contact with) the conductive ink portions 16 (i.e., the “width” of the conductive ink strip/band) correlates with the power output of the heater cable, and contributes (e.g., in combination with the fraction of the circumference of the cores 3 and 4 that are in effective electrical contact with conductive material 6) to the coverage percentile of conductive material covering the surfaces of the cores 3 and 4. The conductive ink portions 16 may be narrow bands that are applied to the cores 3 and 4, or wide bands that cover as much as the entire outer circumferences of the cores 3 and 4. In some embodiments, the conductive ink portions 16 may additionally cover outer surfaces of the web 5 and may provide a continuous covering over the outer surfaces of cores 3 and 4. The conductive ink portions 16 on either side of the SR heater cable 30 may be electrically connected together by the conductive material 6 or, for example, a metal wire that is spiraled to electrically connect the cores 3 and 4.

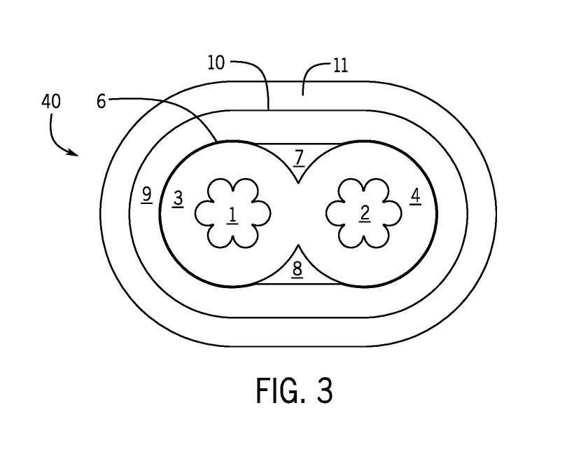

In yet other embodiments, web 5 may be absent, allowing for cores 3 and 4 to be in direct contact with one another (e.g., in a straight arrangement, or in a twisted arrangement). FIG. 3 shows an example of such an embodiment in which cores 3 and 4 of an SR heater cable 40 are in direct contact without the presence of a connecting web. By omitting the web 5 from the SR heater cable 40, the overall diameter of the SR heater cable 40 may effectively be reduced and air gaps 7 and 8 may be made smaller.

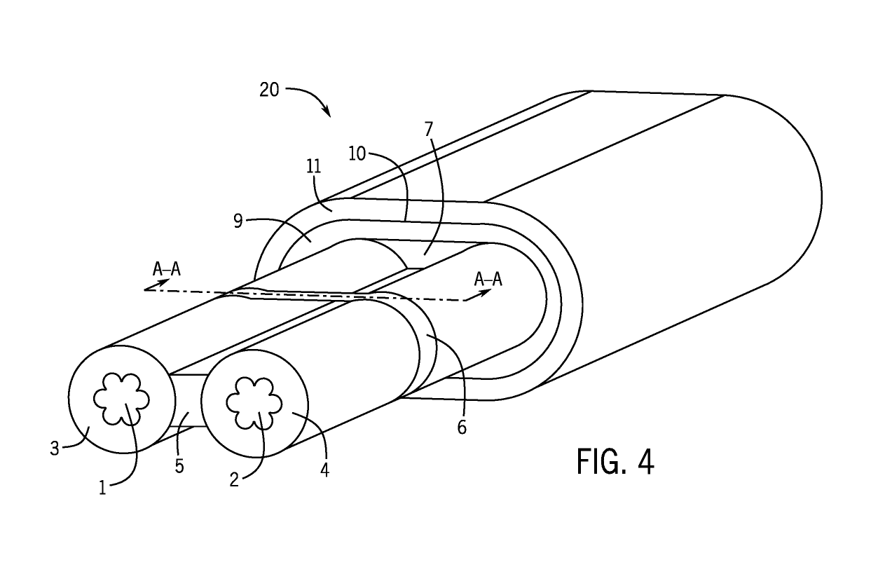

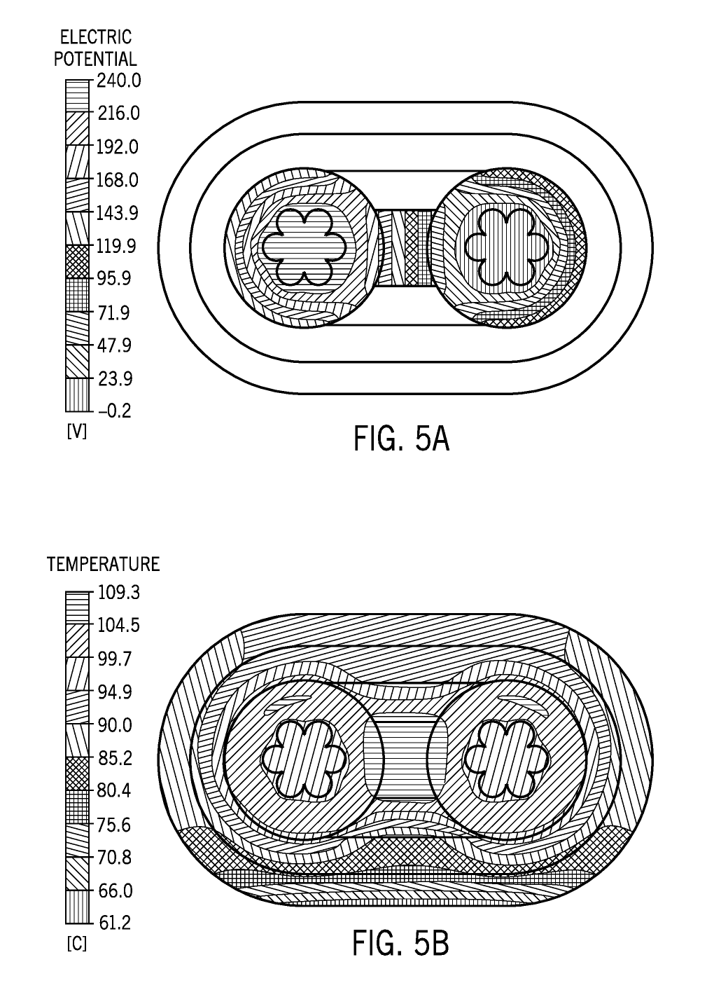

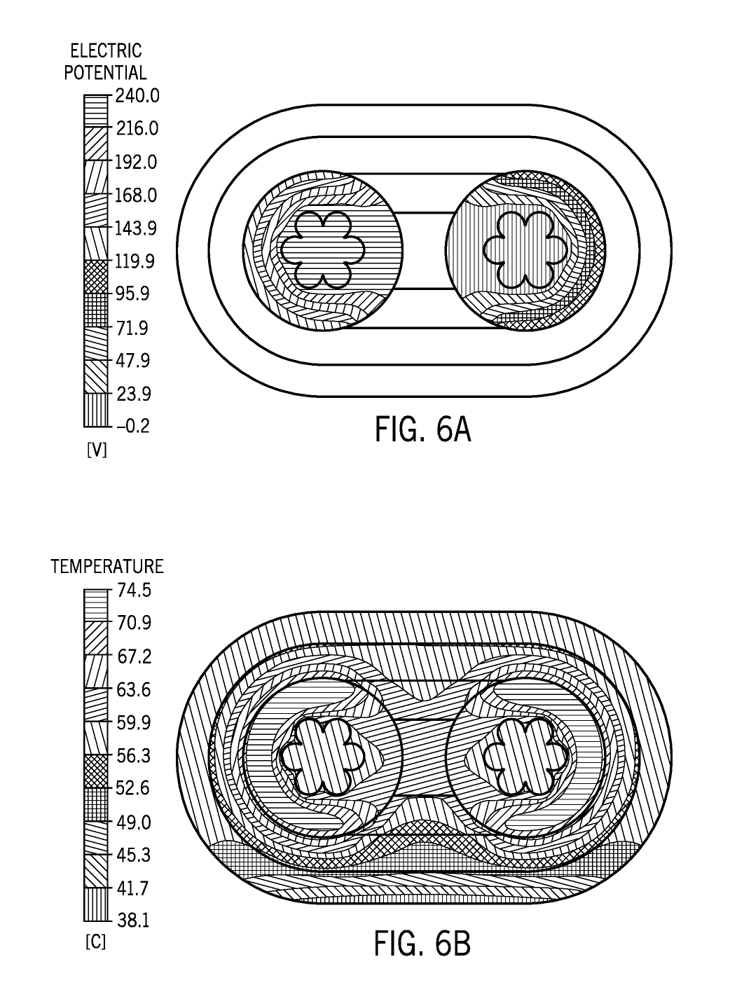

FIG. 4 shows an isometric view of the SR heater cable 20 of FIGS. 1A-1C in which polymer jackets 9 and 11 and ground layer 10 have been pulled back to reveal cores 3 and 4 and conductive material 6. Simulations of electrical potential and temperature during operation were performed for the SR heater cable 20 at a cross-section A-A (corresponding to a cross-section of the SR heater cable 20 that is overlapped by the conductive material 6). These simulations are described below in connection with FIGS. 5A-6B.

FIGS. 5A-5B show a cross-sectional view of simulation results for the SR heater cable 20 along cross-section A-A of FIG. 4 for embodiments in which the SR heater cable 20 includes an electrically active web. The simulation of FIG. 5A shows a radial voltage gradient occurring in the area of the SR heater cable 20 overlapped by the conductive material 6. The simulation of FIG. 5B shows a temperature gradient occurring in the area of the SR heater cable 20 overlapped by the conductive material 6.

FIGS. 6A-6B show a cross-sectional view of simulation results for the SR heater cable 20 along cross-section A-A of FIG. 4 for embodiments in which the SR, heater cable 20 includes an electrically inactive web. The simulation of FIG. 6A shows a radial voltage gradient occurring in the area of the SR heater cable 20 overlapped by the conductive material 6. The simulation of FIG. 6B shows a temperature gradient occurring in the area of the SR heater cable 20 overlapped by the conductive material 6.

Referring to FIGS. 5A and 6A, a radial electric potential (voltage) gradient occurs in the area where the conductive material 6 contacts the cores 3 and 4. Referring to FIG. 5A, if the web 5 is electrically active, a voltage gradient may also be observed across the web 5; consequently, heater cables with active webs 5 may exhibit the characteristics of a hybrid heater cable. Herein, a “hybrid heater cable” refers to a heater cable that generates heat both within cores (e.g., cores 3 and 4) of the heater cable and within an electrically active web (e.g., web 5) between the cores. In contrast, conventional SR heater cables may only generate heat in an electrically active web.

Referring to FIGS. 5B and 6B, temperatures across the cores 3 and 4 may be relatively uniform in the area where the conductive foil 6 is in contact with cores 3 and 4. If the web 5 is electrically active, then a temperature peak may be observed in the midregion of the web 5 where the conductive foil 6 is absent, in which case the heater cable may exhibit characteristics of a hybrid heater cable. It is noted that higher temperatures in web 5 may be contributed to by air gaps 7 and 8 (which provide thermal resistance), which may be due to the low thermal conductivity of air.

The power output of exemplary heater cable configurations may depend on, for example, the composition of the cores 3 and 4, the voltage applied, the substrate temperature, whether the web 5 is electrically active or inactive, and the coverage percentile of the conductive foil 6 and (optionally) the conductive ink portions 16 over the core(s). As an example, for a given core composition, when the SR heater cable 20 is powered at 240 V and placed on a substrate at 10 degrees Celsius, an exemplary heater cable outputs (with no conductive ink portion 16, as shown in FIGS. 1A-1C):

20 W/ft for heater cable configurations with active or inactive webs 5 when the coverage percentile of the conductive material 6 is 100%;

9 W/ft for heater cable configurations with active webs 5 when the coverage percentile of the conductive material 6 is 7%;

4 W/ft for heater cable configurations with inactive webs 5 when the coverage percentile of the conductive material 6 is 7%;

7 W/ft for heater cable configurations with, active webs 5 when the coverage percentile of the conductive material 6 is 0% (e.g., the conductive material 6 is omitted); and

0 W/ft for heater cable configurations with inactive webs 5 when the coverage percentile of the conductive foil is 0% (e.g., the conductive material 6 is omitted).

Therefore, a desired power output of the SR heater cable 20 for given cable configurations can be achieved by selecting the coverage percentile of the conductive material 6 over the cores 3 and 4 (e.g., by selecting a winding density of the conductive material 6 around the cores 3 and 4) during manufacture of the SR heater cable 20. In this way, manufacturing tolerances for the resistivity of the cores 3 and 4 may be made less stringent as, by altering the coverage percentile of the conductive material 6, the power output of the SR heating cable 20 may be adjusted subsequent to the fabrication of the cores 3 and 4. In contrast, the power output of conventional heater cables may be determined primarily by the resistivity of the core of the heater cable. Thus, it may result in material waste when fabricated cores of conventional heater cables have resistivities that are outside of acceptable manufacturing tolerance levels (e.g., which would result in a heater cable that would not meet power output requirements). Thus, when manufacturing SR heating cables according to embodiments of the present invention, material waste may be reduced compared to that of conventional methods.

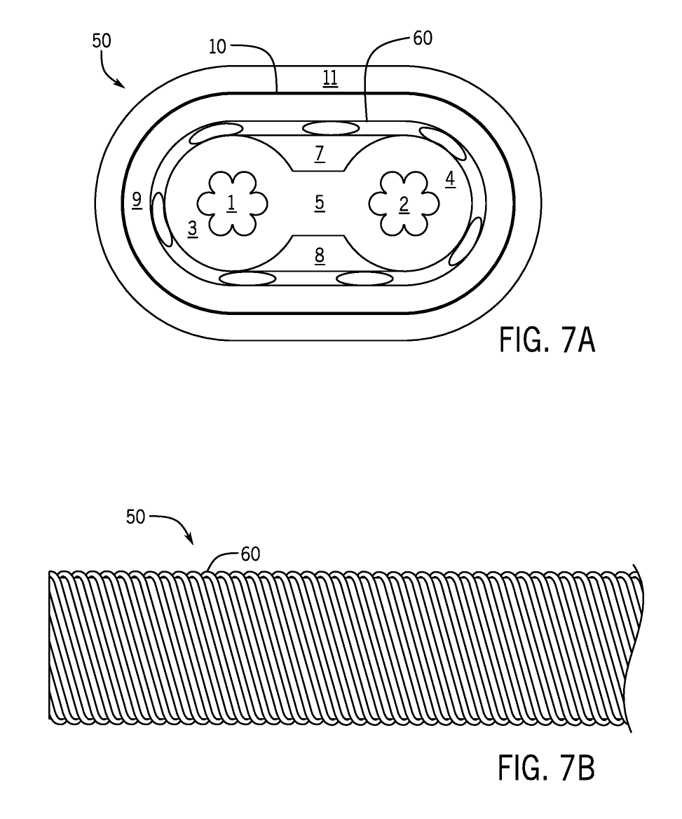

An illustrative “wire wrapped” SR heater cable 50 is shown in FIG. 7A (cross-sectional view) and FIG. 7B (top-down view with polymer jackets 9 and 11 and ground layer 10 not shown) may include one or more wires 60 wrapped on cores 3 and 4 instead of other conductive material options (e.g., conductive foil or conductive ink). Because the wrapping density defines the coverage percentile of the wire 60, the power output of the SR heater cable 50 can be modified by adjusting the wrapping density of the wire 60 (e.g., during manufacture of the SR heating cable 50. The wire 60, for example, may be formed from electrically conductive metal.

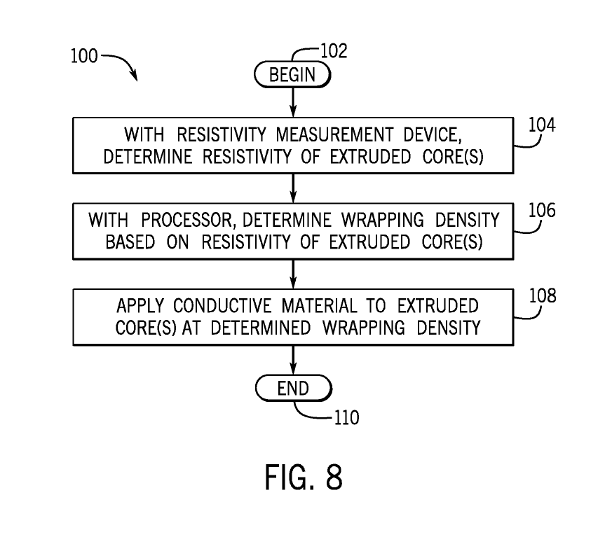

FIG. 8 shows an illustrative process flow for a method 100 for, during manufacture of a SR heating cable (e.g, any of SR heating cables 20, 30, 40 and 50 of FIGS. 1A-1C, FIG. 2, FIG. 3, and FIGS. 7A and 7B), automatically selecting a power output for the SR heating cable by applying conductive material (e.g., conductive wire or foil) to extruded cores at a wrapping density determined based on a measured resistivity of the extruded cores.

At step 102, method 100 may begin. For example, preceding the execution of method 100, one or more extruded cores may be fabricated. The extruded core(s) may encapsulate one or more conductors, which may, for example, be bus wires.

At step 104, the resistivity of the extruded core(s) is determined using a resistivity measurement device. In some embodiments, this resistivity measurement may be performed automatically (e.g., without the need for human intervention in measuring the resistivity of the extruded core(s)).

At step 106, a processor (e.g., a processor of a computer system controlling one or more pieces of manufacturing equipment) automatically determines a wrapping density (e.g, for wrapping electrically conductive material such as wire or foil around the extruded core(s)) based on the determined resistivity of the extruded cores. This determination of the wrapping density may further be determined based on a predefined power output value for the SR heating cable being manufactured. For example, the predefined power output value may be defined (e.g., in memory hardware of the computer system in which the processor is included) according to the desired power output to be exhibited by the SR heater cable being manufactured.

At step 108, manufacturing equipment (e.g., controlled by the processor used to perform step 106) applies electrically conductive material (e.g., electrically conductive wire or foil) around the extruded core(s) at the determined wrapping density. For example, the electrically conductive material may be applied by wrapping electrically conductive wire around the extruded core(s). Alternatively, the electrically conductive material may be applied by adhering electrically conductive foil to the extruded core(s). Alternatively, the electrically conductive material may be applied by printing electrically conductive ink onto the extruded cores (e.g., according to a predefined pattern corresponding to the determined wrapping density). The applied electrically conductive material may be tested and evaluated in order to ensure that the electrically conductive material maintains good electrical contact with the extruded core(s) directly after application and subsequent to heating operations.

At step 110, the method 100 ends once the extruded core(s) have been wrapped with the electrically conductive material at the determined wrapping density. Additional process steps may be subsequently performed on the wrapped extruded cores, such as applying polymer jackets (e.g., polymer jackets 9 and 11 of FIGS. 1A-1C) and a ground layer (e.g., ground layer 10 of FIGS. 1A-1C).

The present invention has been described in terms of one or more preferred embodiments, and it should be appreciated that many equivalents, alternatives, variations, additions, and modifications, aside from those expressly stated, and apart from combining the different features of the foregoing versions in varying ways, can be made and are within the scope of the invention.

It is also noted that, although reference numerals are reused for like components of different embodiments in the figures, the components need not have the same configurations, and the components may have differences from each other in different embodiments.

1. A voltage-leveled self-regulating heater cable comprising:
a conductor;
a core that encapsulates the conductor, the core comprising positive temperature coefficient material; and
a conductive material in contact with only a portion of an outer surface of the core.

2. The voltage-leveled self-regulating heater cable of claim 1 further comprising:
conductive ink in contact with the outer surface of the core and in contact with at least a portion of the conductive material.

3. The voltage-leveled self-regulating heater cable of claim 1, further comprising:
an additional conductor; and
an additional core that encapsulates the additional conductor, the additional core comprising positive temperature coefficient material.

4. The voltage-leveled self-regulating heater cable of claim 3 further comprising:
a first conductive ink portion extending lengthwise along the core; and
a second conductive ink portion extending lengthwise along the additional core.

5. The voltage-leveled self-regulating heater cable of claim 3 further including a web extending between the core and the additional core.

6. The voltage-leveled self-regulating heater cable of claim 5 wherein the web is electrically active.

7. The voltage-leveled self-regulating heater cable of claim 5 wherein the web is electrically inactive.

8. The voltage-leveled self-regulating heater cable of claim 3, wherein the core physically contacts the additional core.

9. The voltage leveled-self-regulating heater cable of claim 1, wherein the conductive material comprises an electrically conductive wire that is wrapped around at a portion of the core.

10. A voltage-leveled self-regulating heater cable comprising:
a first conductor;
a first core that encapsulates the first conductor, the first core comprising positive temperature coefficient material;
a second conductor;
a second core that encapsulates the second conductor, the second core comprising positive temperature coefficient material; and
conductive material in contact with outer surfaces of the first core and the second core, wherein the conductive material electrically couples the first core to the second core, wherein the conductive material is selected from the group consisting essentially of: metal and conductive ink.

11. The voltage-leveled self-regulating heater cable of claim 10, further comprising:
first conductive ink printed on a first portion of the first core; and
second conductive ink printed on a second portion of the second core, wherein the conductive material is in physical contact with the first conductive ink and the second conductive ink.

12. The voltage-leveled self-regulating heater cable of claim 10, wherein the conductive material comprises electrically conductive metal foil that encircles the first and second cores.

13. The voltage-leveled self-regulating heater cable of claim 10, further comprising:
a web interposed between the first core and the second core, the web connecting the first core to the second core.

14. The voltage-leveled self-regulating heater cable of claim 13 wherein web is electrically active.

15. The voltage-leveled self-regulating heater cable of claim 13 wherein web is electrically inactive.

16. A method of manufacturing voltage-leveled self-regulating heater cables, the method comprising:
with manufacturing equipment, applying, to a first pair of extruded cores comprising a positive temperature coefficient material encapsulating a first conductor and a second conductor, conductive material at a first wrapping density to produce a first voltage-leveled self-regulating heater cable that includes the conductive material covering less than 100 percent of the first pair of extruded cores.

17. The method of claim 16, further comprising:
with a resistivity measurement device, automatically determining a resistivity of the first pair of extruded cores.

18. The method of claim 17, further comprising:
with a processor of a computer system, determining the first wrapping density based on at least the determined resistivity of the first pair of extruded cores.

19. The method of claim 16, further comprising selecting the first wrapping density based on a predefined power output for the first voltage-leveled self-regulating heater cable.

20. The method of claim 19, further comprising:
with a resistivity measurement device of the manufacturing equipment, automatically determining a first resistivity of the first pair of extruded cores;
determining, based on the first resistivity, that the conductive material applied to the first pair of extruded cores at the first wrapping density produces the first voltage-leveled self-regulating heater cable with the predefined power output;
with the resistivity measurement device, automatically determining a second resistivity of a second pair of extruded cores comprising the positive temperature coefficient material encapsulating a third conductor and a fourth conductor, the second resistivity being different from the first resistivity;
determining, based on the second resistivity, that the conductive material applied to the second pair of extruded cores at a second wrapping density produces a second voltage-leveled self-regulating heater cable with the predefined power output; and
with the manufacturing equipment, applying, to the second pair of extruded cores, the conductive material at the second wrapping density to produce the second voltage-leveled self-regulating heater cable.

21. The method of claim 16, wherein applying the conductive material to the extruded cores further comprises:
wrapping electrically conductive wire around the first pair of extruded cores at the first wrapping density.
